(19) United States
(12) Patent Application Publication
(10) Pub. No.: US 2022/0164798 A1
(43) Pub. Date: May 26, 2022

(54) SYSTEM AND METHOD FOR DETECTING FRAUDULENT ELECTRONIC TRANSACTIONS

(71) Applicant: ROYAL BANK OF CANADA, Toronto (CA)

(72) Inventors: Vikash YADAV, Toronto (CA); Niloufar AFSARIARDCHI, Toronto (CA); Sahar RAHMANI, Toronto (CA); Amit Kumar TIWARI, Toronto (CA); Cormac O'KEEFFE, Uxbridge (CA); Matin HALLAJI, Toronto (CA); Daniel SWERDFEGER, Toronto (CA); Cheng Chen LIU, Toronto (CA)

(21) Appl. No.: 17/531,161

(22) Filed: Nov. 19, 2021

Related U.S. Application Data
(60) Provisional application No. 63/116,352, filed on Nov. 20, 2020.

(51) Int. Cl. G06Q 20/40; G06N 20/00

(52) U.S. Cl. CPC G06Q 20/4016; G06N 20/00

(57) ABSTRACT

A computer system for, and method of, detecting fraudulent electronic transactions is provided. The system comprises at least one processor and a memory storing instructions which when executed by the processor configure the processor to perform the method. The method comprises accessing a trained model, receiving real-time transaction data, extracting graph-based and statistical features to enrich the real-time transaction data, and determining an account proximity score for the real-time transaction data.

### CROSS REFERENCE TO RELATED APPLICATIONS

This application is a non-provisional of, and claims all benefit, including priority, to U.S. Application No. 63/116,352, dated Nov. 20, 2020 entitled SYSTEM AND METHOD FOR DETECTING FRAUDULENT ELECTRONIC TRANSACTIONS and incorporated herein in its entirety by reference.

### FIELD

The present disclosure relates generally to machine learning, and in particular to a system and method for real-time detection of fraudulent electronic transaction data processes.

### INTRODUCTION

One of the services offered in online banking is an email money transfer between individuals. It is noted that a majority of the banking fraud cases are observed in email money transfers. Current monitoring systems are only able to detect about half of these frauds cases.

### SUMMARY

In one embodiment, there is provided a system for detecting fraudulent electronic transactions. The system comprises at least one processor and a memory storing instructions which when executed by the processor configure the processor to access a trained model, receive real-time transaction data, extract graph-based and statistical features to enrich the real-time transaction data, and determine an account proximity score for the real-time transaction data.

In another embodiment, there is provided a method of detecting fraudulent electronic transactions. The method comprises accessing a trained model, receiving real-time transaction data, extracting graph-based and statistical features to enrich the real-time transaction data, and determining an account proximity score for the real-time transaction data.

In another embodiment, there is provided a system for detecting fraudulent electronic transactions. The system comprises at least one processor, and a memory comprising instructions which, when executed by the processor configure the processor to receive real-time transaction data, enrich the real-time transaction data using historical transaction data, and score the enriched transaction data.

In another embodiment, there is provided a method of detecting fraudulent electronic transactions. The method comprises receiving real-time transaction data, enriching the real-time transaction data using historical transaction data, and scoring the enriched transaction data.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates, in a schematic diagram, an example of a physical environment for a machine learning platform, in accordance with some embodiments

FIG. 2 illustrates, in a flowchart, an example of a process for generating an proximity score model, in accordance with some embodiments;

FIG. 3 illustrates an example of a process for training an instance of the account proximity score model, in accordance with some embodiments;

FIG. 4 illustrates, in a component diagram, an example of a method for detecting fraudulent electronic transactions, in accordance with some embodiments;

FIG. 5 illustrates, in a component diagram, another example of a method for detecting fraudulent electronic transactions, in accordance with some embodiments;

FIG. 6 illustrates, in a flowchart, an example of another process of generating a proximity score model, in accordance with some embodiments;

FIG. 7 illustrates, in a graph, an example of a transaction graph, in accordance with some embodiments;

FIG. 8 illustrates, in a flow diagram, an example of model scoring, in accordance with some embodiments; and

FIG. 9 is a schematic diagram of a computing device such as a server.

It is understood that throughout the description and figures, like features are identified by like reference numerals.

### DETAILED DESCRIPTION

Embodiments of methods, systems, and apparatus are described through reference to the drawings.

It is desirable to detect anomalous email money transfers, based on known fraud cases using graph technology and supervised machine learning model. In some embodiments, graph technology can clearly show proximity of clients to each other, indirect connections between clients, and a community of clients based on payments and payment patterns. A node may represent a client card number, an email address, a mobile phone number, or a unique ID. Email money transfers could be sent to an email address, mobile phone number, or both. Edges represent connecting the nodes, showing number of transactions and sum of transactions.

In some embodiments, three datasets are used: a graph dataset, a training dataset and a test dataset. In some embodiments, the graph dataset shows a relationship/network of clients using 70 days of data (email money transfer and third party payment data). In some embodiments, the training dataset shows transaction level data using 90 days of data, 10 days of rolling window at a time. In some embodiments, the test dataset shows 30 days of data, 10 days of rolling window at a time.

In some embodiments, a graph will show patterns and features. Example of features include i) a local neighborhood of a node (e.g., one degree of separation between nodes); ii) extended neighborhood of a node (e.g., multiple degree of separation between nodes); iii) how often two nodes interact in time (e.g., average time, max time, min time); and iv) structured transactions (e.g., amount, channel (application vs online banking). In some embodiments, a total of 50 features are extracted from the graph.

Graphs are useful for extracting single-hub and multi-hub features about the nodes in the graph. Single-hub features, such as node degree, count of transactions originating at the node depends on the immediate neighbours of the node and captures local information in the graph, while the multi-hub features such as page rank which measures the importance of a node with respect to other nodes in the graph capture global information about the node. Single-hub and multi-hub features extracted from graph provides important historic information about the transaction sender, recipient and their interaction for the machine learning model to identify fraudulent transaction patterns.

In some embodiments, an XGBoost machine learning model may be used. It is understood that other machine learning model applications can also be used. Some models have graph capability and scalability using Spark and Hadoop.

In some embodiments, a real-time detection technique in provided which identifies client proximity by building more complex analytics around the connection between the sender and recipient of the transaction. The detection method can complete end-to-end processing, from reading the data to writing the score back, within up to approximately 500 milliseconds.

In some embodiments, graph-based and statistical features combined with real-time model serving capabilities may be used.

In some embodiments, a real-time detection technique, using graph analytics and a machine learning approach, to detect fraudulent email money transfers is provided. In some embodiments, the implementation technique can respond within up to 500 milliseconds and serve up to 300 requests per second.

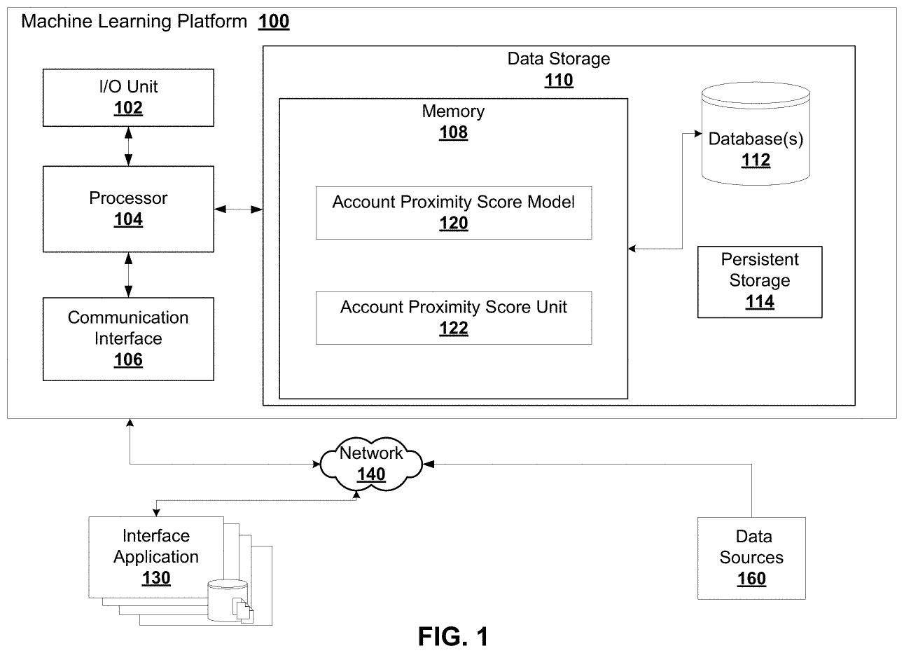

FIG. 1 illustrates, in a schematic diagram, an example of a physical environment for a machine learning platform 100, in accordance with some embodiments. The platform 100 may be an electronic device connected to interface application 130 and data sources 160 via network 140. The platform 100 can implement aspects of the processes described herein for controllable machine text generation architecture.

The platform 100 may include a processor 104 and a memory 108 storing machine executable instructions to configure the processor 104 to receive a machine learning model (from e.g., data sources 160). The processor 104 can receive a trained machine learning model and/or can train a machine learning model using training engine 124. The platform 100 can include an I/O Unit 102, communication interface 106, and data storage 110. The processor 104 can execute instructions in memory 108 to implement aspects of processes described herein.

The platform 100 may be implemented on an electronic device and can include an I/O unit 102, a processor 104, a communication interface 106, and a data storage 110. The platform 100 can connect with one or more interface devices 130 or data sources 160. This connection may be over a network 140 (or multiple networks). The platform 100 may receive and transmit data from one or more of these via I/O unit 102. When data is received, I/O unit 102 transmits the data to processor 104.

The I/O unit 102 can enable the platform 100 to interconnect with one or more input devices, such as a keyboard, mouse, camera, touch screen and a microphone, and/or with one or more output devices such as a display screen and a speaker.

The processor 104 can be, for example, any type of general-purpose microprocessor or microcontroller, a digital signal processing (DSP) processor, an integrated circuit, a field programmable gate array (FPGA), a reconfigurable processor, or any combination thereof.

The data storage 110 can include memory 108, database(s) 112 and persistent storage 114. Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 110 can include memory 108, databases 112 (e.g., graph database), and persistent storage 114.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 can connect to different machines or entities.

The data storage 110 may be configured to store information associated with or created by the platform 100. Storage 110 and/or persistent storage 114 may be provided using various types of storage technologies, such as solid state drives, hard disk drives, flash memory, and may be stored in various formats, such as relational databases, non-relational databases, flat files, spreadsheets, extended markup files, etc.

The memory 108 may include an account proximity score model 120, and an account proximity score unit 122. The account proximity score model 120 and an account proximity score unit 122 will be described in more detail below.

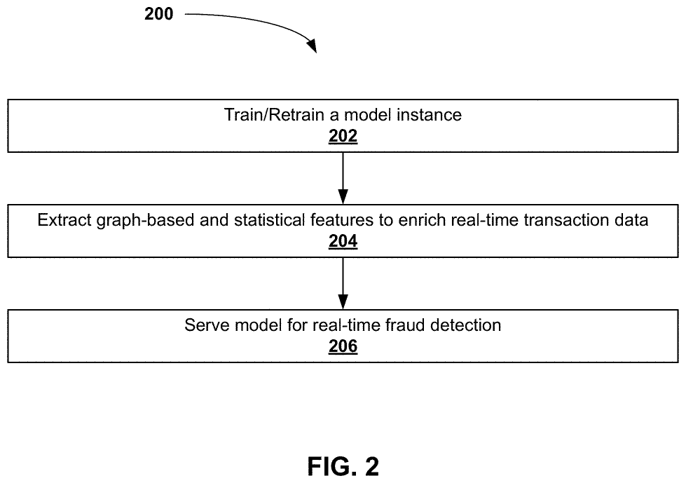

FIG. 2 illustrates, in a flowchart, an example of a process 200 for generating an proximity score model, in accordance with some embodiments. The account proximity score model training process 200 may be performed by the account proximity score unit 122 to train the account proximity score model 120. The method comprises training/retraining a model instance 202, extracting graph-based and statistical features to enrich real-time transaction data 204, and serving the trained model for real-time fraud detection 206. Other steps may be added to the method 200.

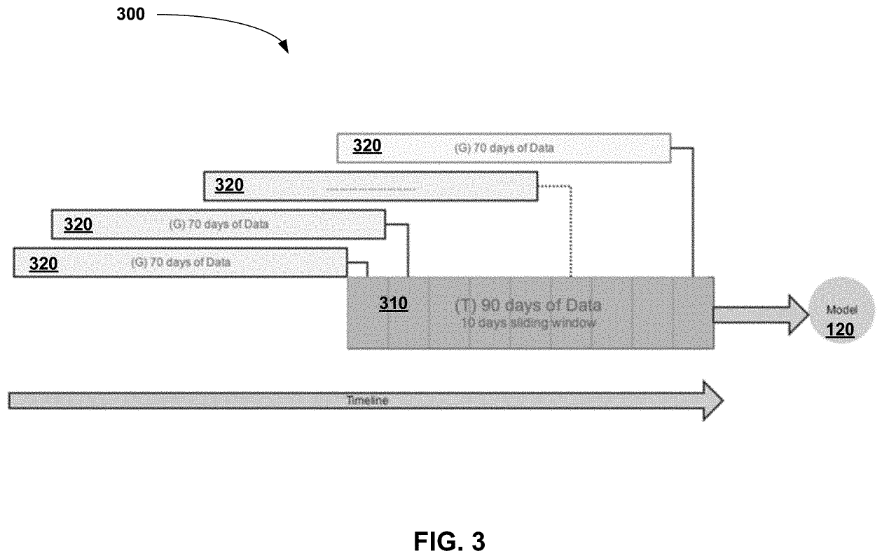

FIG. 3 illustrates an example of a process 300 for training an instance of the account proximity score model, in accordance with some embodiments. Initially the model instance is trained 202 on a certain number of days (e.g., 90 days; it is understood that another period of time may be used) worth of historical transactional data 310 (e.g., historical email transfer data) which been labelled correctly by fraud agents as fraudulent or non-fraudulent. These 90 days of the training period is divided into a number of buckets 320 (e.g., 9; it is understood that another period of time may be used) of a number of days (e.g., 10 days; it is understood that another period of time may be used) each.

Each transaction comprises information about the sender and recipient of the transaction along with the amount of money being transferred. To augment this information to be able to train a good classifier, these transactions are enriched 204 with relevant features for the sender and recipient extracted from their past (historical) transaction behaviour. These relevant features may be constructed from a number of days (e.g., 70 days; it is understood that another period of time may be used) of transaction preceding the training bucket. Transactions in each 10 days training bucket it is understood that another period of time may be used for the training bucket) are enriched with relevant features extracted from the preceding 70 days of transactions. Once the enriched labelled dataset is ready, a supervised machine learning technique may be used to train a model instance. The same process is repeated periodically (e.g., every month; it is understood that another period of time may be used) to re-train the model instance.

Once a model is trained, it may be used to score transactions in real-time 206. Similar to the enrichment process for training data, real-time transactions may be enriched before applying the model to get the account proximity score. For consistency, the preceding 70 days of transactions (alternatively, it is understood that another period of time may be used) to extract the relevant features. These features may be refreshed periodically (e.g., every 10 days; it is understood that another period of time may be used) to use the latest transaction behaviours of the users. These extracted features may be used to enrich the transactions in real-time and score a transaction using the model.

In order to meet a real-time response requirement for some embodiments, an end-to-end process 400, 500 should be completed in less than 500 milliseconds (it is understood that another period of time may be used) and should handle an average volume of around 300 requests per second (it is understood that another volume may be used). Each of the steps may be optimized to achieve the required performance.

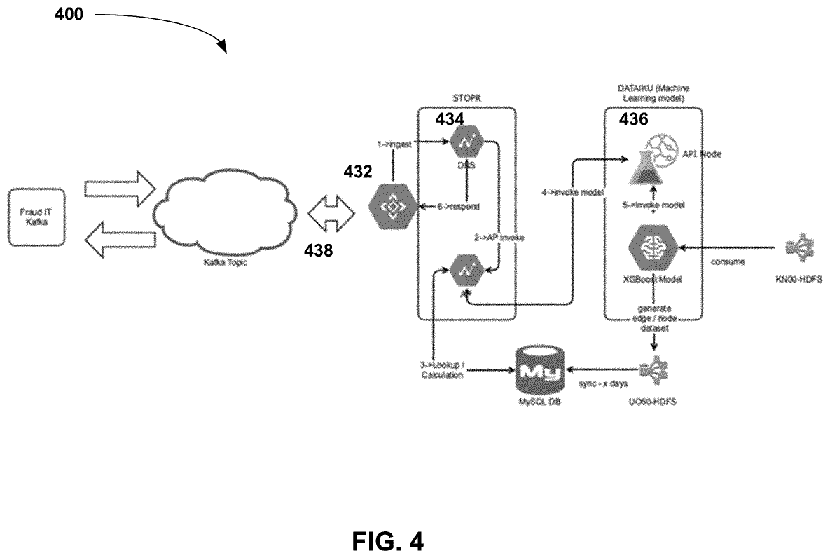

FIG. 4 illustrates, in a component diagram, an example of a method 400 for detecting fraudulent electronic transactions, in accordance with some embodiments. The method 400 may be performed by the account proximity score unit 122 and comprises reading a message topic 432, enrichment 434, model scoring 436, and writing back to the topic 438.

In some embodiments, new transactions are received 432 for scoring using a Kafka queue. Reading and writing to Kafka is relatively fast.

In some embodiments, to speed up the enrichment process 434, relevant features are extracted from preceding 70 days (it is understood that another period of time may be used) of the user's transaction history and store it in a database (e.g., My SQL relational database) in the form of a lookup table. These tables may be indexed on lookup keys to achieve fast retrieval. The entire enrichment process is completed through a platform (e.g., a STOPER platform). In some embodiments, the platform uses simple lightweight python instructions to lookup the My SQL database and extracts the pertinent features for the enrichment of the transaction. Few other simple transformations are also done before the transaction is passed to the model for scoring.

In some embodiments, the machine learning model instance may be made available 436 through a dataiku automation node. The Dataiku tool provides the ability to deploy any machine learning model as an application programming interface (API) such that it can be used by making a simple curl request to the API. An average time for a curl request to get score is around 10 milliseconds. Instead of using the dataiku tool to run the model instance, it could be replaced with any other platform which can similarly serve the machine learning model without breaking the rest of the steps. For example, the model could also be deployed using a docker container running on a pivotal cloud foundry (PCF).

Once the machine learning model returns the score to STOPER, it is written back 438 to a Kafka topic for the end-user to consume the score.

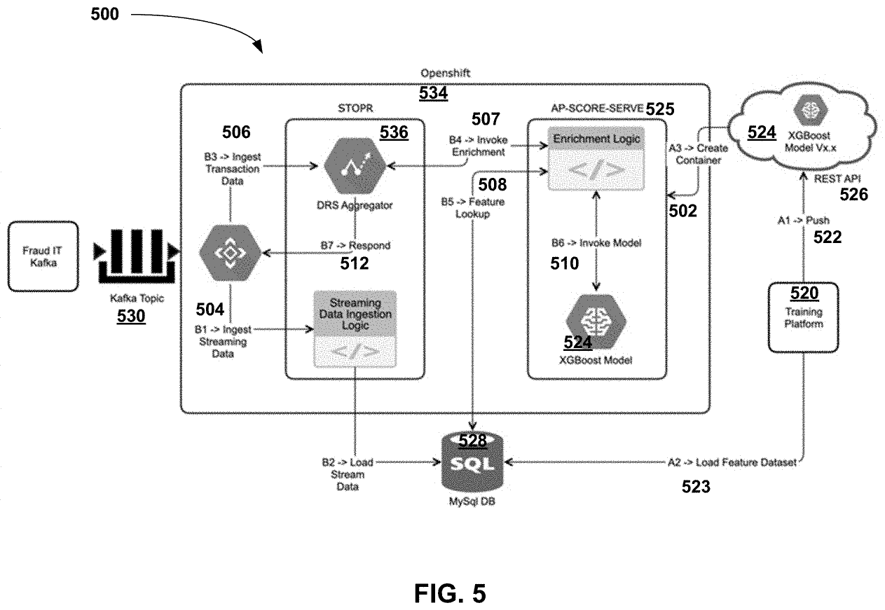

FIG. 5 illustrates, in a component diagram, another example of a method 500 for detecting fraudulent electronic transactions, in accordance with some embodiments. The method 500 may be performed by the account proximity score unit 122 and comprises receiving a model 502, reading a fraudulent transaction message from a topic 504, reading a new transaction message 506, enrichment of the transaction details 508, model scoring 510, and writing back to the topic 512. Other steps may be added to the method 500.

A training platform 520 (e.g., Dataiku) may periodically (e.g., every 30 days; it is understood that another period of time may be used) push 522 a new trained model instance 524 the real-time model serving platform 525 (e.g., through a REST API 526). Additionally, the periodic features extracted to enrich the real-time transactions may be loaded 523 into a database 528 (e.g., MySQL database) as well.

Newly reported fraudulent cases may be received in streaming fashion from Kafka and are stored in MySQL 528 for new real-time transactions enrichment 508. The reported fraudulent cases may be read 504 from the Kaftk topic 530.

New transactions are received 506 for scoring using Kafka queue and are passed on 507 to Account Proximity (AP) machine learning models for scoring and the response is written back 512 to Kafka topic 530. Reading and writing to Kafka is relatively fast.

To speed up the enrichment process, relevant features are extracted 508 from the preceding 70 days of the user's transaction history and stored in My SQL relational database 528 in the form of a lookup table. These tables are indexed on lookup keys to achieving fast retrieval. In some embodiments, The enrichment process is completed through AP-SCORE-SERVE platform 534. The platform 534 uses simple lightweight python instructions to lookup 508 the My SQL database 528 and extracts the pertinent features for the enrichment of the transaction. Other simple transformations may also be done before the transaction is passed to the model for scoring.

The machine learning model instance is containerized and hosted on a platform 534 such as OpenShift. It has been observed that an average time for an invoke model request to get scored is around 20 milliseconds.

Once the machine learning model returns the score to STOPR 536, it is written back 512 to a Kafka topic 534 for the end-user to consume the score. The determination of the score will be described in more detail below.

In some embodiments, feature extraction is performed using a graph built using 70 days of historic transactions. Usually, a longer period for feature extraction is better as the graph is able to capture more of the client's activity and cyclical behaviour pattern, albeit at the cost of computational efficiency. It was found that a 70 day period strikes a good balance between the two.

In some embodiments, the model refreshes every 30 days. A new model is trained every 30 days so that it may keep up with the latest fraudulent behaviour patterns. Since training a new model is a computation-intensive task which includes preparing 90 days of the training set (9 iterations, 10 days data in each iteration), it was found that a shorter training period would be too computationally expensive to realize any additional uplift.

In some embodiments, feature refresh occurs every 10 days. As new accounts and new payment connections are constantly formed by clients, these new changes should be accounted for while enriching the transaction for real-time scoring. An experiment with a shorter feature refresh period of every 3 days was performed. It found that only marginal improvements in the uplift while adding significant computational expense. Hence, it was determined to use 10 days for feature refresh.

In some embodiments, account proximity features include local node neighbourhood features, extended node neighbourhood features, time series features, and structured transactional features.

In some embodiments, local node neighbourhood feature include:

xcn_amt_sum: the sum of historical amount (CAD) transferred from source to destination

frd_amt_sum: the amount of historical fraud (CAD) previously transferred from source to destination

frd_cnt_sum: the count of historical fraudulent transaction from source to destination

src_amt_total_send: total amount (CAD) source sent in historical data

src_outDegree: out degree of source in historical graph

src_total_cnt_send: total count of historical transactions sent by source

src_outgoing_frd_cnt: the count of fraudulent historical transactions initiated from source

src_outgoing_frd_amt: the amount (CAD) of fraudulent historical transactions initiated from source

src_amt_total_rec: total amount (CAD) source received in historical data

src_inDegree: in degree of source in historical graph

src_total_cnt_rec: total count of historical transactions received by source

src_incoming_frd_cnt: the count of fraudulent historical transactions targeted source

src_incoming_frd_amt: total amount (CAD) of fraudulent transactions in historical data targeted source

src_amt_percentage_above_avg: percentage of the transaction amount to the average amount sent from this source node

src_degree: degree of source in historical graph

dst_amt_total_send: total amount (CAD) destination sent in historical data

dst_outDegree: out degree of destination in historical graph

dst_total_cnt_send: total count of historical transactions sent by destination

dst_outgoing_frd_cnt: the count of fraudulent historical transactions initiated from destination

dst_outgoing_frd_amt: the amount (CAD) of fraudulent historical transactions initiated from destination

dst_amt_total_rec: total amount (CAD) destination received in historical data

dst_inDegree: in degree of destination in historical graph

dst_total_cnt_rec: total count of historical transactions received by destination

dst_incoming_frd_cnt: the count of fraudulent historical transactions targeted destination

dst_incoming_frd_amt: total amount (CAD) of fraudulent transactions in historical data targeted destination

dst_degree: degree of destination in historical graph

dst_frd_mrk: boolean flag that indicates whether there has been a confirmed fraud on this email/mobile in the period of 10 days to 15 minutes before the transaction time

novel_device_ip: boolean flag that indicates whether this ip has been seen in the previous transactions between this source-destination pair

novel_dst: boolean flag that indicates whether the destination node has been seen before or not

In some embodiments, extended node neighbourhood features include:

fw_sp: shortest path in the historic transaction graph between sender and recipient (directed graph)

rev_sp: shortest path in historic transaction graph between recipient and sender (directed graph)

src_core_num: it is a measure that can help identify tightly interlinked groups within a network. A k-core is a maximal group of entities, all of which are connected to at least k other entities in the group.

dst_core_num: it is a measure that can help identify tightly interlinked groups within a network. A k-core is a maximal group of entities, all of which are connected to at least k other entities in the group.

src_scc_size: size of the connected component/community of the sender in historic transaction graph

dst_scc_size: size or the connected component/community of the recipient in historic transaction graph

src_pgrank: log of sender's page rank/importance with respect to other nodes in the graph

dst_pgrank: log of recipient's page rank/importance with respect to other nodes in the graph

src_w_pg_rnk: log of sender's weighted (number of transactions) page rank/importance with respect to other nodes in the graph

dst_w_pg_rnk: log of recipient's weighted (number of transactions) page rank/importance with respect to other nodes in the graph

email_mbl_cc_size: size of email/mobile entity in the historic transaction graph

scc: categorical feature that indicate whether the source-destination pair are in “same”, “different”, and “inactive” connected component. “inactive” means either source or destination is never seen before.

In some embodiments, time series features include:

xcn_tmstmp_unix_lag_diff_max: the maximum of time interval (in seconds) between consecutive historical transactions from source to destination

xcn_tmstmp_unix_lag_diff_min: the minimum of time interval (in seconds) between consecutive historical transactions from source to destination

xcn_tmstmp_unix_lag_diff_avg: the average of time interval (in seconds) between historical transactions from source to destination

In some embodiments, structured transactional features include:

xcn_amt: transaction amount (CAD) transferred from source to destination

xcn_amt_log: log of transaction amount (CAD) transferred from source to destination

device_type: Mobile App vs Browser

dst_type: categorical feature that shows whether EMD is sent to “email”, “mbl”, or “both”

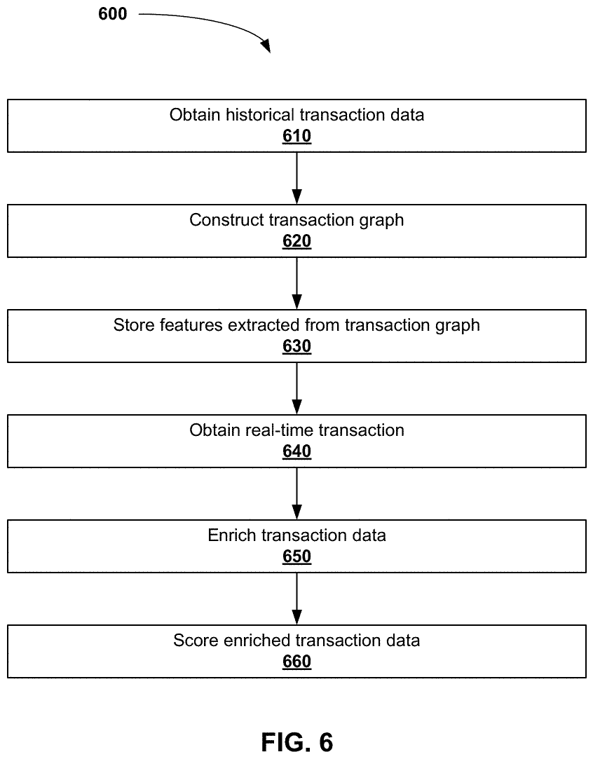

FIG. 6 illustrates, in a flowchart, an example of another process of generating a proximity score 600, in accordance with some embodiments. The method 600 comprises obtaining historical transaction data 610, constructing a transaction graph 620, storing 630 features extracted from the transaction graph, obtaining a real-time transaction 640, enriching the transaction data 650, and scoring the enriched transaction data 660. Other steps may be added to the method 600, such as classifying a transaction based on a proximity score, and triggering a rule based on the classification.

At step 610, historical transaction data may be obtained. For example, 70 days of historical data may be read. Table 1 shows an example transaction data collected and read:

TABLE 1
Sample Transaction Data

| | | Trans- | Recipient | | | |
|---|---|---|---|---|---|---|
| Transaction | Card | action | Card | Payee | Payee | |
| Time | Number | Type | Number | Email | Mobile | Amount |
| 2019 Nov. 1 | CC1 | EMD | | | T1 | 20 |
| 2019 Dec. 1 | CC1 | EMD | | | T1 | 35 |
| 2019 Dec. 31 | CC1 | EMC | | E1 | | 30 |
| 2019 Nov. 20 | CC2 | EMD | | E2 | | 15 |
| 2019 Nov. 1 | CC3 | EMD | | E2 | | 1000 |
| 2019 Dec. 1 | CC3 | 3PD | CC2 | | | 100 |
| 2019 Dec. 31 | CC4 | EMD | | E1 | | 30 |
| 2019 Dec. 31 | CC4 | EMD | | E2 | | 10 |
| 2019 Oct. 23 | CC5 | EMD | | E1 | | 100 |
| 2019 Dec. 10 | CC5 | EMD | | E3 | T2 | 10 |

In this example, EMD represents Email Money Debit, EMC represents Email Money Credit and 3PD represents Third party Debit.

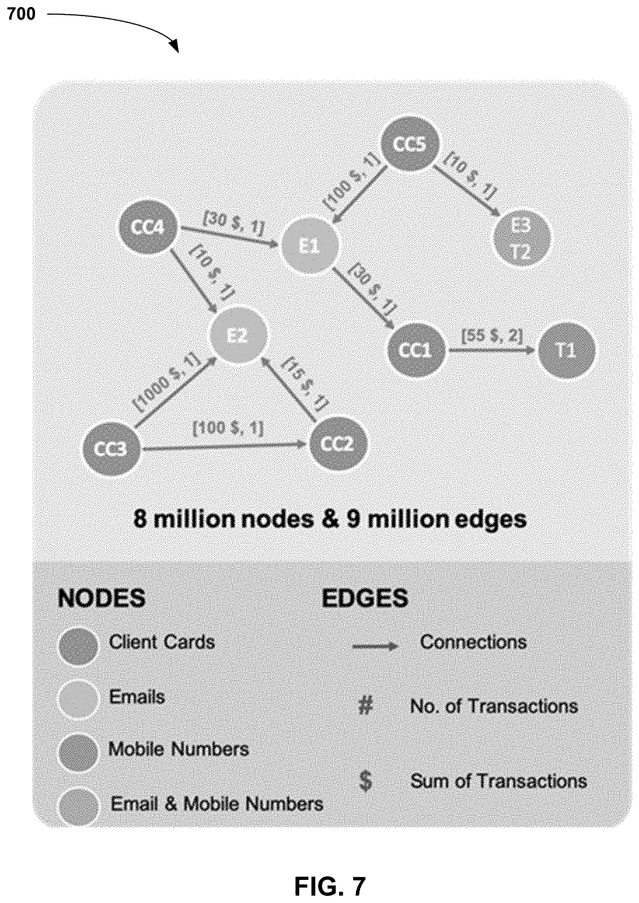

At step 620, a transaction graph may be constructed from the historical transaction data. FIG. 7 illustrates, in a graph, an example of a transaction graph 700, in accordance with some embodiments. In this example, the transaction graph 700 is constructed from the prior 70 days of historic data. In some embodiments, the transaction graph 700 may comprise eight million nodes and nine million edges. Data may be extracted from the transaction graph 700, including connections between node types (client cards, emails, mobile numbers, email & mobile numbers, etc.), a number of transactions per connection, and a sum of transactions per connection, local and extended node neighbourhood features described above, etc.

In some embodiments, data may be enriched using multiple sources of transaction details. For example, transaction details from two or more financial institutions or other external payment channels may be collected as part of the historical transaction data. In some embodiments, multiple sources of real-time transaction details may be obtained and analysed. For example, a first financial institution may receive data feeds from a second financial institution (and/or from an external payment channel) to collect and store historical transaction details that may be used to increase the scope of constructed transaction graphs.

In an operational example, if a first financial institution client X sends email money transfer to client Y from another financial institution, and client Y then sends money to another first financial institution client Z, then the first financial institution internal data alone will not be able to capture the indirect connection between the first financial institution clients X and Z. By using an other data source (e.g., an external payment channel details), the first financial institution would be able to form such indirect connections between the client X and Z while constructing the transaction graph. This would result in improved feature quality extracted from the transaction graph. In one embodiment, based on initial experimentation, a potential for 26% increase in uplift generated by the model was seen.

At step 630, relevant features extracted from the transaction graph may be stored in a MySql database to be used to enrich the transactions in real-time. Tables 2 to 4 illustrate an example of a MySql Relational Table:

TABLE 2
Sample Node Data

| Entity | amt_total_send | amt_total_rec | outDegree | inDegree | pgrank | ... |
|---|---|---|---|---|---|---|
| CC1 | 55 | 30 | 1 | 1 | 0.1557 | |
| CC2 | 15 | 100 | 1 | 1 | 0.0862 | |
| CC3 | 1100 | | 1 | | 0.0605 | |
| CC4 | 40 | | 2 | | 0.0605 | |
| CC5 | 110 | | 2 | | 0.0605 | |
| E1 | 30 | 30 | 1 | 1 | 0.1119 | |
| E2 | | 1025 | | 3 | 0.1853 | |
| T1 | | 55 | | 1 | 0.1928 | |
| E3 T2 | | 10 | | 1 | 0.0862 | |

TABLE 3
Sample Edge Data

| src | dst | xcn_amt_sum | count | xcn_tmstmp_unix_lag_diff_min | . . . |
|---|---|---|---|---|---|
| CC1 | T1 | 55 | 2 | 2592000 | |
| CC2 | E2 | 15 | 1 | | |
| CC3 | CC2 | 100 | 1 | | |
| CC3 | E2 | 1000 | 1 | | |
| CC4 | E1 | 30 | 1 | | |
| CC4 | E2 | 10 | 1 | | |
| CC5 | E1 | 100 | 1 | | |
| CC5 | E3 | 10 | 1 | | |
| | T2 | | | | |
| E1 | CC1 | 30 | 1 | | |

TABLE 4
Shortest Path of Sample Data

| src | dst | sp |
|---|---|---|
| CC1 | T1 | 1 |
| CC4 | CC1 | 2 |
| CC5 | CC1 | 2 |
| CC4 | T1 | 3 |
| CC3 | E2 | 1 |
| . . . | . . . | . . . |

At step 640, a real-time transaction may be read from a Kafka topic. Table 5 shows an example of a transaction table:

TABLE 5
Sample Transaction Table

| Transaction | Card | Transaction | Payee | Payee | Transaction | |
|---|---|---|---|---|---|---|
| Time | Number | Type | Email | Mobile | Amount | ... |
| 2020 Jan. 1 | CC1 | EMD | E2 | | 30 | ... |

At step 650, the real-time transaction data may be enriched using the graph features stored in the MySql database. Table 6 shows an example of an enriched transaction table:

TABLE 6

| Sample Enriched Transaction Table | | | | | | | | | | | |
|---|---|---|---|---|---|---|---|---|---|---|---|
| Transaction | Card | Transaction | Payee | Payee | Transaction | | | | | | |
| Time | Number | Type | Email | Mobile | Amount | src_amt_total_send | src_outDegree | dst_inDegree | xcn_amt_sum | fw_sp | ... |
| 2020 Jan. 01 | CC1 | EMD | E2 | | 30 | 55 | 1 | 1 | 55 | 1 | ... |

At step 660, the enriched transaction data may be scored using a trained XGBoost Model. An XGBoost Model, is a decision-tree-based ensemble Machine Learning algorithm that uses a gradient boosting framework. An XGBoost software library may be used to train a model. During the training phase, hundreds of decision trees may be learned from the labeled training data, each optimized to correct the misclassification from the previous iteration. The precise structure of each decision tree and how the final score is produced by the trained model for an enriched transaction is handled by the software library package and is unknown to the end user.

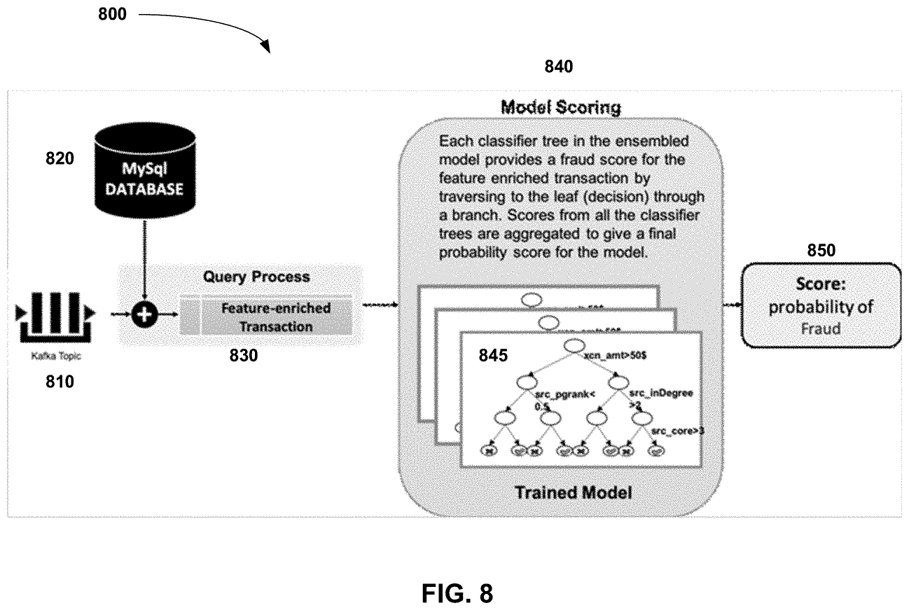

FIG. 8 illustrates, in a flow diagram, an example of model scoring 800, in accordance with some embodiments. Real-time transaction data is received from a Kaftka Topic 810 and enriched from transaction data stored in a MySql database 820. The feature-enriched transaction data 830 is sent to a trained model 840 to be scored. Each classifier tree 845 in an ensemble model 840 provides a fraud score for the feature enriched transaction by traversing to leaf (decision) through a branch. Scores from all the classifier trees 845 are aggregated to give a final probability score 850 for the model. In some embodiments, the final probability score may be displayed as a declaration or “fraud” or “valid”/“not fraud”.

In some embodiments, a financial institution or other party to a transaction may classify the transaction into two or more categories, including “fraud”, “indeterminate” or “valid/not fraud” based on a final probability score range assigned to each category. Other categories may be envisioned. Each category may have an associated rule that triggers how to process the transaction. For example, the “fraud” category may result in the transaction being rejected. The “valid/not fraud” category may result in the transaction being processed. Indeterminate categories may be set to either allow or not allow transactions to proceed. In some embodiments, a time limit may be placed on a category to provide time for independent analysis of the transaction. Some indeterminate categories may be set to allow the transaction to proceed after the expiry of that time limit if no rejection is received from the independent analysis. Other indeterminate categories may be set to reject the transaction after the expiry of the time limit if no approval is received from the independent analysis.

In some embodiments, rules may be toggled or otherwise suspended if too many false positives are found to be present. A false positive ratio per rule may be measured. An example of a false positive ratio is (the number of false positive alerts per rule)/(the number of true positive alerts). In some embodiments, when the false positive ratio per rule is over a set threshold, then the system may suspend that rule and allow the transaction to proceed. In some embodiments, the system will continue to track/tag the transaction per rule for future analysis and/or statistics. If the ratio lowers below the set threshold, then that rule may be reinforced. Future analysis of the transaction alerts for a rule where transactions are tracked/tagged following suspension of the rule may provide insight into fraudulent activity trends on a periodic basis. Should several rules be found to be suspended, or the model otherwise found to be less than optimal, then the model may be reengineered. For example, model hyperparameters (e.g., the depth of decision trees in the model, the number of decision trees in the model, etc.) may be optimized.

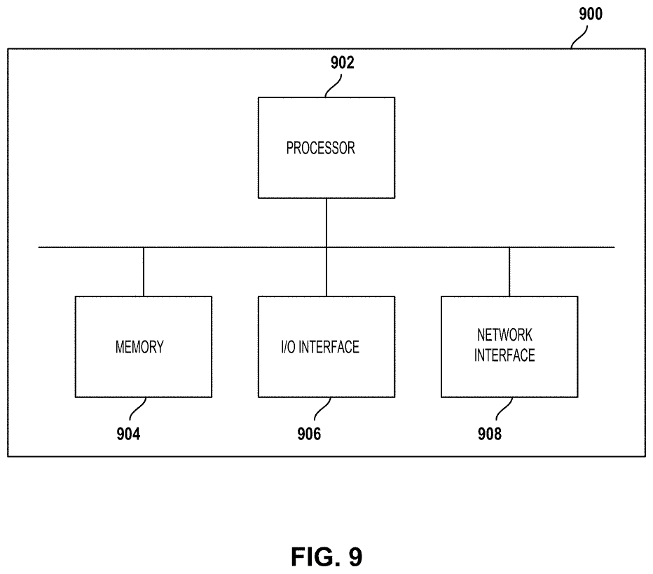

FIG. 9 is a schematic diagram of a computing device 900 such as a server. As depicted, the computing device includes at least one processor 902, memory 904, at least one I/O interface 906, and at least one network interface 908.

Processor 902 may be an Intel or AMD x86 or x64, PowerPC, ARM processor, or the like. Memory 904 may include a suitable combination of computer memory that is located either internally or externally such as, for example, random-access memory (RAM), read-only memory (ROM), compact disc read-only memory (CDROM).

Each I/O interface 906 enables computing device 900 to interconnect with one or more input devices, such as a keyboard, mouse, camera, touch screen and a microphone, or with one or more output devices such as a display screen and a speaker.

Each network interface 908 enables computing device 900 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A system for detecting fraudulent electronic transactions, the system comprising:
at least one processor; and
a memory comprising instructions which, when executed by the processor, configure the processor to:
access a trained model;
receive real-time transaction data;
extract graph-based and statistical features to enrich the real-time transaction data; and
determine an account proximity score for the real-time transaction data.

2. A system for detecting fraudulent electronic transactions, the system comprising:
at least one processor; and
a memory comprising instructions which, when executed by the processor, configure the processor to:
receive real-time transaction data;
enrich the real-time transaction data using historical transaction data; and
score the enriched transaction data.

3. The system as claimed in claim 2, wherein the at least one processor is configured to:
obtain the historical transaction data; and
construct a transaction graph based on the historical transaction data.

4. The system as claimed in claim 3, wherein the at least one processor is configured to:
extract features from the transaction graph; and
store the extracted features in a database.

5. The system as claimed in claim 2, wherein the at least one processor is configured to:
traverse at least one classifier tree in a trained model to obtain a fraud score for each classifier tree; and
aggregate each fraud score for each classifier tree to obtain a total probability of fraud score.

6. The system as claimed in claim 2, wherein the at least one processor is configured to classify the real-time transaction based on the score.

7. The system as claimed in claim 6, wherein the at least one processor is configured to classify the real-time transaction into at least one of:
fraud, triggering a rejection of the transaction;
valid, wherein the transaction is permitted to proceed; or
indeterminate, triggering an independent analysis of the transaction.

8. The system as claimed in claim 7, wherein the transaction is classified as indeterminate, and the transaction is permitted if an independent rejection is not received after a period of time.

9. The system as claimed in claim 7, wherein the transaction is classified as indeterminate, and the transaction is rejected if an independent allowance is not receive after a period of time.

10. A method of detecting fraudulent electronic transactions, the method comprising:
receiving real-time transaction data;
enriching the real-time transaction data using historical transaction data; and
scoring the enriched transaction data.

11. The method as claimed in claim 10, comprising:
accessing a trained model;
receiving real-time transaction data;
extracting graph-based and statistical features to enrich the real-time transaction data; and
determining an account proximity score for the real-time transaction data.

12. The method as claimed in claim 10, comprising:
obtaining the historical transaction data; and
constructing a transaction graph based on the historical transaction data.

13. The method as claimed in claim 12, comprising:
extracting features from the transaction graph; and
storing the extracted features in a database.

14. The method as claimed in claim 13, comprising:
traversing at least one classifier tree in a trained model to obtain a fraud score for each classifier tree; and
aggregating each fraud score for each classifier tree to obtain a total probability of fraud score.

15. The method as claimed in claim 10, comprising classifying the real-time transaction based on the score.

16. The method as claimed in claim 15, comprising classifying the real-time transaction into at least one of:
fraud, triggering a rejection of the transaction;
valid, wherein the transaction is permitted to proceed; or
indeterminate, triggering an independent analysis of the transaction.

17. The method as claimed in claim 16, wherein the transaction is classified as indeterminate, and the transaction is permitted if an independent rejection is not received after a period of time.

18. The method as claimed in claim 16, wherein the transaction is classified as indeterminate, and the transaction is rejected if an independent allowance is not receive after a period of time.
